(19) United States
(12) Patent Application Publication
(10) Pub. No.: US 2009/0254469 A1
(43) Pub. Date: Oct. 8, 2009

(54) System for Cash, Expense And Withdrawal Allocation Across Assets and Liabilities to Maximize Net Worth Over a Specified Period

(76) Inventor: Michael Paul Robertson, New York, NY (US)

Correspondence Address: Michael Robertson, 222 E 34 APT 2017, New York, NY, 10016, US

(21) Appl. No.: 12/098,438

(22) Filed: Apr. 6, 2008

(51) Int. Cl. G06Q 40/00

(52) U.S. Cl. 705/35

(57) ABSTRACT

This invention constitutes a method for taking a set of input parameters specifying a person or family's assets, liabilities, income and expenses and computing the optimal amount of cash to withdrawal from each credit source or asset (including liquidation of physical assets, credit card balance transfers, and use of loan sources) and the allocation of expenses and cash flow across assets and liabilities so as to maximize net worth by a particular date. The method consists of computing marginal and average expense and return functions for each asset and liability to do a no-withdrawal monthly optimization from the start month to the target month on which to maximize net worth, then recursively computing optimal withdrawal amounts for each source of capital on specific months, ultimately finding the optimal withdrawal amount for each source on each of these months and returning the optimal allocation of expenses and the resulting income and cash-flow across assets and liabilities. This invention is being applied to an online environment, where the user inputs the necessary details and optimization takes place on the server.

### CROSS-REFERENCE OF RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This system involves the processing of financial data, specifically the computerized analysis of this data for planning purposes. This patent is, in particular, for a process of analyzing an individual or family's financial data that utilizes a computer algorithm to give the optimal allocation of resources across various instruments so as to maximize net worth at a specified future date subject (or not) to constraints such as liquidity requirements and interest rate exposure caps. Inputs include assets and liabilities, income sources and expenses including credit cards (allowing for balance transfers, expiring APRs, and fees), mortgages, loans, and physical and cash assets with different tax treatments.

There are patented systems prior to this invention with tangentially related results. For example, Atkins (U.S. Pat. Nos. 5,911,136, 5,852,811) presents multiple patents covering systems that, with a specified horizon, optimally allocate cash to maintain a balance between assets and liabilities targeting a bank-mandated minimum borrowing power. The systems forecast economic variables and incorporate budget constraints, but centrally involve user's mortgage, as the systems explore mortgage lender's efforts to sell other financial services to borrowers. By contrast, the nature of this invention is such that no such mortgage is required to produce a useful result. Other systems have been patented that address the problem of asset allocation across risky investments given the financial goals of a client (see U.S. Pat. No. 6,430,542) or to allocate investments in a tax-efficient way (U.S. Pat. No. 7,031,937). There are also systems that utilize the Capital-Asset Pricing Model (CAPM) to allocate investments (U.S. Pat. No. 6,078,904). Finally, there are financial modeling systems that allow a user to interactively change their investment strategies and produce a forecast of returns (U.S. Pat. No. 5,220,500).

A core shortcoming of the existing state of the art is that it fails to effectively combine the spectrum of financial assets and liabilities that people have today into a simple platform with an optimal allocation across instruments to maximize net worth. There are tools to analyze stock portfolios; there are tools to analyze mortgages and tools to compare credit card offers. But none of these tools analyze a person's credit cards and credit card offers, loans, mortgages, physical assets, etc. to direct them how to most effectively manage, liquidate, borrow from or invest in different resources to maximize their overall net worth.

The problem itself is presented to every individual in the economy, and is particularly relevant for people who are faced with substantial credit card debt and other liabilities. However, the calculation of how much cash to allocate or withdrawal from different sources every month over the time period is path-dependent and nontrivial. Credit cards can have very involved terms and because of expiring APRs on many cards, can have time-dependent interest liability. Balance transfers and cash withdrawals make these cards more useful but also more complex for individuals to use without ultimately causing financial strain. Among other things this system calculates when it is optimal to sell physical assets to pay off liabilities and when to transfer balances from one card to another given the interest rate on both and expected future cash flow. This can be helpful to people who are uncertain of how best to pay off existing credit card debt, but can also be used to perform optimized cash-flow calculations for different scenarios.

For example, a person trying to decide whether to (a) buy and mortgage a house or (b) rent the same can input both scenarios, optimize the cash flows and compare the net worth of both in ten years to find the ultimate cost difference in net worth terms based on their current and projected financial situation. The impact of this decision is a complex function of the user's current and forecast financial situation and the effect of the choice on future cash flow can lead to quite different optimal allocations of expenses, withdrawals and payments in future months. The principal value-added of this system is that all of the complexity of calculating these optimal payments is handled automatically, enabling fast, optimal scenario analysis in addition to producing a description of the optimal allocation itself.

### BRIEF SUMMARY OF THE INVENTION

This system utilizes a computer algorithm and inputs specifying a financial scenario, different constraints and a time horizon to maximize the user's calculated net worth on the specified target date by allocating cash flow and expenses and making withdrawals from sources of capital. Sources of capital include loans, financial accounts and physical assets that can be liquidated for cash. In maximizing net worth, the calculated net worth differs from the usual economic definition of net worth in that physical assets can be valued at a “personal value,” which could be different from liquidation value. This ensures that physical assets are only liquidated if their cash value is more useful for wealth maximization over the time period than the personal value of the asset.

The algorithm categorizes inputs as assets, liabilities, income sources and expenses and accepts loans, mortgages, credit cards, assets (real and financial), income and monthly expenses. For any financial scenario (defined as a specification of the various parameters of each of each element in each category), the algorithm produces a baseline optimization to allocate expenses and cash flow, then recursively considers different withdrawal options (e.g., balance transfers, liquidations, or borrowing) for each capital source over the set of computed “critical months” where the optimal withdrawal amounts may be non-zero. The end result is a statement of the optimal allocation of cash, expenses and withdrawals and an estimate of maximal net worth given the inputs on the target date.

In one use of the system, it is accessed via a web browser where some calculations are done locally, and other more computationally intensive operations are done server-side on the computer hosting the site. More computationally intensive operations include the actual application of the optimization algorithm to the inputs, whilst the analysis of properties of the inputs (such as time to pay-off a given credit card assuming a minimum or optimal payment process) are done locally.

The algorithm itself returns to the client-facing front-end an array of optimal payments and withdrawals for each input and a projection of the net worth from the start to the target date in one month intervals. This is done via a database. When the algorithm is complete, the front-end queries the database to obtain the payments and withdrawals for each input and presents the result to the user.

### BRIEF DESCRIPTION OF THE SEVERAL VIEWS OF THE DRAWING

Not applicable.

### DETAILED DESCRIPTION OF THE INVENTION

This section provides a detailed description of the net worth optimization algorithm, starting with the inputs specification.

There are two types of inputs required for the algorithm. The first are the parameters to use—the target month (example, February 2018) on which the projected net worth is to be maximized and the relevant tax information, specifically the user's tax brackets for federal, state and municipal income tax. The second input is an array of financial instruments consisting of six types: (1) income sources, (2) mortgages, (3) credit cards, (4) loans, (5) expenses, and (6) assets. Each of these has different properties used by the algorithm.

(1) Income Sources

In the basic algorithm each income source has a total amount per annum. The algorithm assumes that the income is received at the end of each month in monthly installments.

(2) Mortgages

Mortgages are specified by the current property value, current principal on the mortgage, property appreciation/depreciation rate per year, expiration on the mortgage, interest rate as an APR, whether or not the interest payments tax deductible and whether the interest is variable (assumed to move with LIBOR) or fixed.

(3) Credit Cards

Credit cards are the most complex instrument with the following parameters. Note that under the current algorithm, exceeding the limit on the card is not permitted. It would, however, be a trivial modification to add an over the limit fee and allow optimization flexible enough to consider exceeding the limit. The parameters are, limit (maximum permitted balance), balance (total current balance on the card), purchases APR (annual percentage rate applied to purchases), minimum payment percent (minimum fraction of the balance that must be paid each month), minimum payment amount (minimum dollar amount per payment), whether the card accepts balance transfers, total current balance transfers on the card, transfers APR (APR applied to balance transfers), whether the transfers APR expires, expiration date (if applicable) for the transfers APR, the percentage fee applied to balance transfers, whether the card has a cap on the balance transfer fee and the corresponding max fee if applicable, and finally whether interest rates are variable or fixed.

(4) Loans

Loans are implemented using the same data structure as mortgages, except that the monthly payment is entered instead of being computed using an expiration date. Also loans do not have an associated property value. Properties are the principal of the loan, the monthly payment, the interest rate, whether the interest is tax deductible, and whether the interest is variable or fixed.

(5) Expenses

In the basic algorithm expenses are assumed to be monthly and recurring. A trivial modification would allow optimization with one-time projected future and current expenses. Expenses have two properties, the amount and whether or not the expense can be paid using a credit card.

(6) Assets

Assets have the following properties: current asset value; cost to liquidate (input as a percentage of the asset value); whether the asset is real or financial; a personal appreciation rate if the asset is real; when the asset is taxed—(1) immediately (meaning the interest is immediately taxable as income), (2) upon liquidation (meaning the gains on the sale are taxed), or (3) nontaxable—and finally whether the interest rate is variable or fixed. If the asset is taxable upon liquidation, the basic algorithm assumes the proceeds are taxable at the marginal income tax rate. A straightforward modification would allow for consideration of a different capital gains rate. For real assets, a personal value rate is used in addition to a liquidation value rate so that the asset has two values at any given time that grow at different rates—a value to the user, which grows at the personal rate, and a value upon liquidation, which grows at the regular appreciation rate. For example, if the user inputs a family car that they own the value they place on the car may grow at 0% while the market value may depreciate 10% a year.

Overview of Optimization Method

The algorithm requires at minimum one financial asset (where excess cash can be placed) and a source of income. The method proceeds by first identifying a set of “critical months”—months (m) that meet one of the following criteria: m is the first month or m is a month in which a credit card introductory APR expires. If the algorithm were extended to allow one-off or repeating future income sources, expenses or available loans, the start dates for these expenses or income sources would also be critical months. A critical month is one in which it is potentially optimal to withdrawal some amount of or liquidate assets or do balance transfers or take out new loans to gain additional cash to allocate that month. In non-critical months, monthly expenses are allocated but it is not optimal to withdrawal any additional cash by these means.

To illustrate, if a set of inputs has only one critical month (the first month), the algorithm would consider a number of possible withdrawal amounts. For each candidate withdrawal, the algorithm would compute a “baseline optimization” for the critical month through the final month in order to estimate the net worth on the final month. This baseline optimization allocates expenses and cash flow each month but does not consider possible withdrawals. On the first month (as on any critical month) the baseline optimization includes the withdrawal amounts being considered as cash flow and allocates them as it would income. However, the allocation process is changed somewhat for inputs from which cash has been withdrawn or expenses allocated.

By comparing the resulting final net worth estimates for each considered withdrawal option, an optimal withdrawal amount for each source of capital can be determined for the first month. With the added cash on the first month, baseline optimization determines the optimal additional payments for each input in each month.

If there are multiple critical months, each time the algorithm considers a different withdrawal amount for the first month, to estimate the final net worth it computes the baseline optimization from the first month to the next critical month, then considers various withdrawals on that second critical month choosing the withdrawal amount for each input to maximize the final net worth. In this way, the algorithm is recursively computing withdrawal amounts on each critical month with the depth of the recursion being equal to the number of critical months. Within this general framework, the requisite steps are (1) a process for efficiently considering different withdrawal amounts from each source and (2) the method for allocating expenses and cash flow using baseline optimization. Let me first describe baseline optimization, ignoring for the time being the possibility of withdrawing cash from different assets or capital sources.

Baseline Optimization

Suppose that we ignore the possibility of withdrawing cash from different sources, but instead assume that on every month we know how much income there is to spend and what the monthly expenses are. In fact, the income on any month may in part come from a liquidation of an asset, but baseline optimization takes the income amounts and expenses as given and allocates the expenses and income optimally for each month over a specified range of months. Thus the inputs are

(1) initial state

(2) number of months

(3) income each month

(4) expenses each month and the outputs are

(1) state on the last month

where a “state” is the set of parameters needed to completely reconstruct the user's inputs (so, the balance and other parameters of all credit cards, assets, loans, etc.). The baseline optimization proceeds by starting with the initial state and allocating cash and expenses, modifying the state based on these allocations, then repeating the process on the new state until it reaches the last month in the range, then returns this final state.

Every month, expenses that can be paid using a credit card are first allocated across cards and non-physical assets. This is done using the following method. First the total of expenses payable by credit is counted for the month. A loop runs through each credit card and non-physical asset in this month's state and gets from it an array of marginal costs per dollar versus additional dollars of expenses allocated to that source. Among all of the first elements in the arrays, the expenses are allocated to the source with the lowest marginal cost up to the point where that marginal cost changes or the source can accept no additional expenses.

Once expenses are allocated, base optimization allocates income less expenses that are not payable by credit. The process is similar to that for allocating expenses, with a few important differences. First, all elements that can accept cash are considered (that is, all input types except income, expenses, and physical assets). Second, instead of computing the marginal cost per dollar of expenses, a marginal benefit per dollar is computed. The marginal benefit accounts for already allocated expenses and withdrawals on each element as a separate element in the array of marginal benefits that is returned. As an example, consider a credit card with the following parameters:

(1) Limit $10,000

(2) Balance $5,000

(3) Annual APR 12%

(4) Min Payment Percent 2%

(5) Min Payment Amount $10

(6) Transferred $2,500

(7) Transfers APR 0%

(8) Balance transfer/cash fee: 3%

(9) Max fee: $100

(10) Expenses: $500

(11) Withdrawals: $500

Then so far this month $500 was withdrawn from the card and $500 worth of expenses was paid using the card. If we allocate an additional dollar to the card, the marginal dollar will initially be used to reverse the withdrawals and expenses applied to the card. Then once all withdrawals and expenses are reversed, the marginal dollar is applied to the transferred balance on the card until transfers are paid off and finally the marginal dollar is applied to the purchases balance. The marginal payment and max amounts array would be the following, with the first element being the marginal savings and the second being the total max dollar amount that can be allocated (such that $5,939.50 is the amount required to pay off the card in full at the end of the first month including reversing the withdrawal and expenses):

[0.01, 500], [0, 3015], [0.01, 5939.50]

The third important difference between the expenses allocation and income allocation is that because, as illustrated in the example, the marginal return on each dollar invested in the instrument is not a monotonically decreasing function of the amount invested, the optimal allocation is not found by repeatedly allocating to the first marginal segments with the highest marginal return. Instead, the marginal return curves are classified as either Type 1—marginally decreasing—or Type 2—marginally increasing over a period. The marginal return curve is classified as Type 2 if the last segment's marginal return is strictly greater than the first. Therefore, the example above is initially classified as Type 1, but if $500 gets allocated to the card in the first iteration, when the marginal return curves are recomputed it will be classified as Type 2, since the curve will then be characterized by

[0, 2515], [0.01, 5439.5].

For Type 2 marginal return curves, for comparing with other elements in each iteration for the optimal allocation, the average return per dollar for the maximum allocation is used rather than the marginal return. Thus in the example, instead of using the marginal return arrays above to compare, the following would be used

[0.00537641327, 5439.5].

The last major difference between the income allocation and expense allocation parts of base optimization is that the income allocation divides the process into two general stages—the first allocation being done as described above using a multiple of the income to allocate with the final allocation (based on cash actually available) being allocated from the top down in order of the highest realized average return per dollar from the first stage. The reason for this approach is to allocate optimally to Type 2 marginal return investments in cases where there is inadequate cash available in any one month, but sufficient cash over the period, to realize the higher marginal returns on larger investments.

Withdrawal Calculation

Baseline optimization solves the problem of how to optimally allocate expenses and income given an inflexible, although possibly time-variant, income stream each month. However, it does not solve the problem of when to liquidate real assets or when and how much to withdrawal from cash sources (e.g., financial assets like savings accounts, or loan sources such as credit cards permitting balance transfers). The withdrawal calculation is done on every critical month (always starting with the first month) and proceeds, as noted before, recursively—by considering each possible withdrawal amount from each source on each critical month. Note, of course, that the set of possible (and, in particular, optimal) withdrawals on each critical month depends on the withdrawals chosen on previous critical months so that the calculation is path-dependent. Therefore for each considered withdrawal amount on the first month, each considered withdrawal amount on future critical months must be re-computed to compare the terminal net worths for different possibilities the first month and, ultimately, to arrive at a set of optimal withdrawals for all critical months. Of course, results can be memorized to avoid recalculating subpaths. Combined with the optimal payments computed using baseline optimization, this provides the solution to the terminal net worth problem: withdrawal amounts, cash allocation and expense allocation for each month from the first to the last.

I will describe the algorithm as applied to the first month. Since it is recursive, the same process is applied deeper in the recursion on future months. First, a base net worth is computed assuming no withdrawals on this critical month. Next, given the current state, each source of capital is considered one-by-one. For each source, three values are computed assuming no other changes to the current state: (1) optimal withdrawal amount (maximizing terminal net worth), (2) maximal terminal net worth with this withdrawal amount and (3) average improvement (versus zero withdrawal) to optimal net worth per extra dollar withdrawn. Using these three results for each source of capital, if the source with the highest value for (3) has a value for (2) greater than the baseline net worth for the current state, then the current state is modified to add withdrawal amount (1) in this month for the source. If (1) is equal to the maximum amount that could have been withdrawn from this source, then the loop repeats, removing from the list of candidate sources of capital this source and any sources for which (1) was zero in this iteration. Once there are no sources of capital left, the loop exits, having found the optimal withdrawal amounts for each source and returns the optimal payments/withdrawals by merging the withdrawals and payments this month with the stream of payments/withdrawals resulting from calling the same function for next month.

The terminal net worth, and trivially average improvement per dollar withdrawn, is computed using the current withdrawals estimated for this month, doing baseline optimization to the next critical month and recursively repeating the process on the next critical month to produce the optimal terminal net worth given current withdrawals.

The optimal amount to withdrawal for each source is computed as follows. Each time a different withdrawal amount is considered, the terminal net worth is estimated using the aforementioned process. The withdrawal amount yielding the highest terminal net worth (which amount could be zero) is returned as the optimal withdrawal. First, the optimum withdrawal is bounded between zero and the max withdrawal amount for the source (e.g., the remaining balance that a credit card will allow in transfers, or the limit on a revolving line of credit). The method is to narrow the window between the upper and lower bound until the difference is below a threshold, then return the upper bound. Second, The terminal net worth is calculated for the max withdrawal amount. Then the optimal payments from the resulting optimization (necessary to compute the terminal net worth) are analyzed. If in the first month, the extra cash resulting from the withdrawal from this source is used to pay back the withdrawal on the source, then the upper bound on the optimal amount is reduced from the maximal withdrawal to the max withdrawal less the amount optimally paid back in the first month. Using the new upper and lower bounds, the process does a standard function maximization, minimizing the required function calls, to find the conditional optimal withdrawal amount for this source.

I claim:

1. A method for allocating current and forecast cash flow across assets and liabilities through the calculation of marginal and average return functions and derivatives of these functions to maximize net worth on a future date.

2. A method for calculating the optimal (in the net worth maximization sense) allocation of expenses and cash across assets and liabilities specifically by allocating expenses using computed marginal and/or average cost curves, modifying the marginal and average return functions such that initial returns (up to the dollar amount of the expense allocated to the asset or liability) reflect the return of reversing the expense, and finally proceeding to allocate cash as per claim 1.

3. A method for recursively calculating the optimal amount of capital to withdrawal from each source of capital—including balance transfers from credit cards and cash withdrawals, liquidation of physical assets, and the withdrawal of funds from revolving loan sources or from financial assets—so as to maximize net worth once this cash is re-allocated across assets and liabilities.

4. A system utilizing the methods of claims 1 through 3 or any trivial modification of these methods through a computer system to advise customers or model different cases of one's own, a theoretical or another person or family's financial situation
